(19) United States
(12) Patent Application Publication
(10) Pub. No.: US 2025/0362451 A1
(43) Pub. Date: Nov. 27, 2025

(54) OPTICAL DEVICE AND METHOD OF MANUFACTURE

(71) Applicant: Taiwan Semiconductor Manufacturing Co., Ltd., Hsinchu (TW)

(72) Inventors: Chen-Hua Yu, Hsinchu (TW); Hsing-Kuo Hsia, Jhubei City (TW); Ren-Fen Tsui, Taipei (TW); Yu-Hung Lin, Taichung City (TW); Pei-Hsuan Lo, Hsinchu County (TW); Jui Lin Chao, New Taipei City (TW); Yu-Hao Kuo, Hsinchu County (TW)

(21) Appl. No.: 18/672,321

(22) Filed: May 23, 2024

(51) Int. Cl. G02B 6/122; G02B 6/12; G02B 6/13

(52) U.S. Cl. CPC G02B 6/1228; G02B 6/13; G02B 2006/12173

(57) ABSTRACT

Optical devices and methods of manufacture are presented in which a substrate is placed on a platform inside an optical imaging device, the optical imaging device comprising a first mask, the first mask having a first opening with a first tapered mask portion having a first shape. The first mask is used to image a photosensitive layer into a photomask, and the photomask is used to pattern a core material into a first waveguide, the first waveguide having a first tapered portion corresponding to the first tapered mask portion, the first tapered portion having a second shape different from the first shape.

### BACKGROUND

Electrical signaling and processing is one technique for signal transmission and processing. Optical signaling and processing have been used in increasingly more applications in recent years, particularly due to the use of optical fiber-related applications for signal transmission.

Optical signaling and processing are typically combined with electrical signaling and processing to provide full-fledged applications. For example, optical fibers may be used for long-range signal transmission, and electrical signals may be used for short-range signal transmission as well as processing and controlling. Accordingly, devices integrating long-range optical components and short-range electrical components are formed for the conversion between optical signals and electrical signals, as well as the processing of optical signals and electrical signals. Packages thus may include both optical (photonic) dies including optical devices and electronic dies including electronic devices.

### BRIEF DESCRIPTION OF THE DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIG. 1 illustrates a silicon on insulator substrate, in accordance with some embodiments.

FIGS. 2A-2B illustrate an imaging process, in accordance with some embodiments.

FIGS. 3A-3B illustrate a formation of first optical components including a first waveguide, in accordance with some embodiments.

FIG. 4 illustrates further processes to form the first optical components, in accordance with some embodiments.

FIG. 5 illustrates deposition of a cladding material, in accordance with some embodiments.

FIGS. 6A-6B illustrate formation of second optical components including a second waveguide, in accordance with some embodiments.

FIG. 7 illustrates formation of a first bonding layer, in accordance with some embodiments.

FIG. 8 illustrates bonding of a first semiconductor device, in accordance with some embodiments.

FIG. 9 illustrates attachment of a support substrate, in accordance with some embodiments.

FIG. 10 illustrates formation of fourth optical components, in accordance with some embodiments.

FIG. 11 illustrates formation of through device vias, in accordance with some embodiments.

### DETAILED DESCRIPTION

The following disclosure provides many different embodiments, or examples, for implementing different features of the invention. Specific examples of components and arrangements are described below to simplify the present disclosure. These are, of course, merely examples and are not intended to be limiting. For example, the formation of a first feature over or on a second feature in the description that follows may include embodiments in which the first and second features are formed in direct contact, and may also include embodiments in which additional features may be formed between the first and second features, such that the first and second features may not be in direct contact. In addition, the present disclosure may repeat reference numerals and/or letters in the various examples. This repetition is for the purpose of simplicity and clarity and does not in itself dictate a relationship between the various embodiments and/or configurations discussed.

Further, spatially relative terms, such as “beneath,” “below,” “lower,” “above,” “upper” and the like, may be used herein for ease of description to describe one element or feature's relationship to another element(s) or feature(s) as illustrated in the figures. The spatially relative terms are intended to encompass different orientations of the device in use or operation in addition to the orientation depicted in the figures. The apparatus may be otherwise oriented (rotated 90 degrees or at other orientations) and the spatially relative descriptors used herein may likewise be interpreted accordingly.

Embodiments will now be discussed with respect to certain embodiments in which a mask pattern is sized to reduce the linewidth of subsequently formed waveguides. The embodiments presented, however, are intended to be illustrative and are not intended to limit the ideas presented to the precise embodiments described. Rather, the ideas presented may be incorporated into a wide variety of embodiments (including within any suitable technologies such as laser integration, photonic integrated circuits, silicon photonics, passive devices, 3-D ICs with photonics application, lasers, compact universal photonic engine (COUPE)), and all such embodiments may be included within the overall scope of the disclosure.

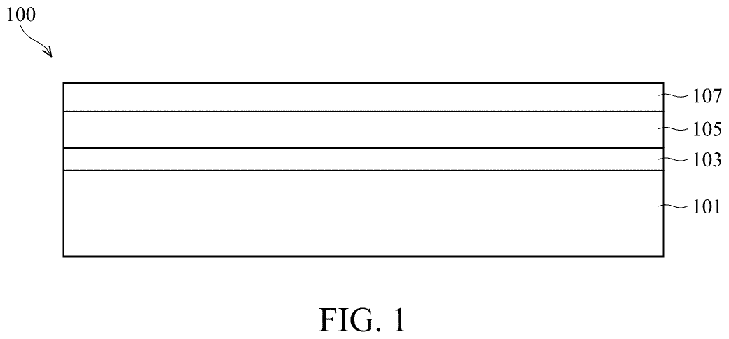

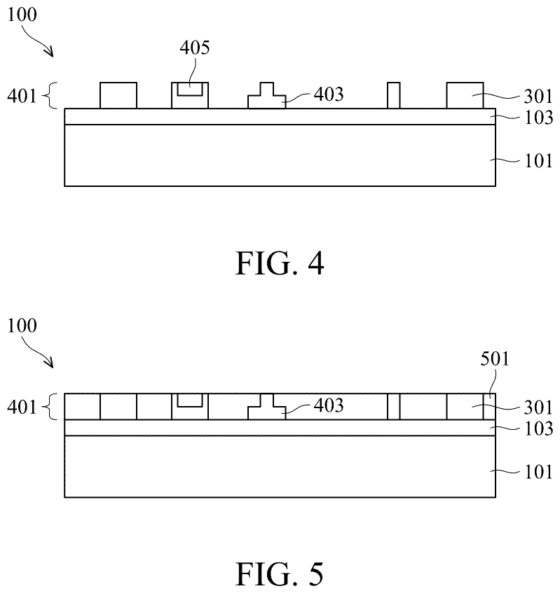

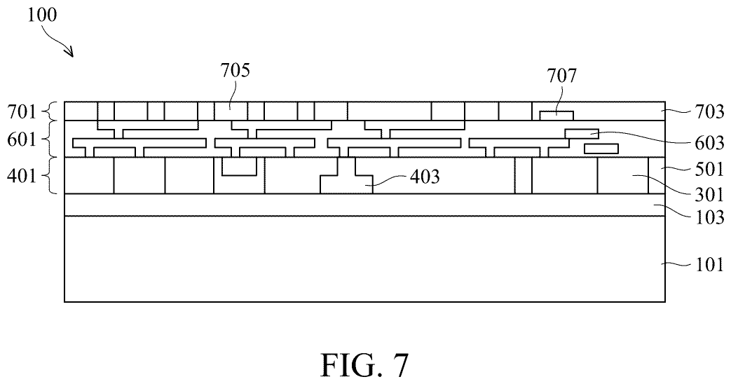

With reference now to FIG. 1, there is illustrated an initial structure of an optical interposer 100 (seen in FIG. 7), in accordance with some embodiments. In the particular embodiment illustrated in FIG. 1, the optical interposer 100 is a photonic integrated circuit (PIC) and comprises at this stage a first substrate 101, a first insulator layer 103, and a layer of material 105 for a first active layer 401 of first optical components 403 (not separately illustrated in FIG. 1 but illustrated and discussed further below with respect to FIG. 4). In an embodiment, at a beginning of the manufacturing process of the optical interposer 100, the first substrate 101, the first insulator layer 103, and the layer of material 105 for the first active layer 401 of first optical components 403 may collectively be part of a silicon-on-insulator (SOI) substrate. Looking first at the first substrate 101, the first substrate 101 may be a semiconductor material such as silicon or germanium, a dielectric material such as glass, or any other suitable material that allows for structural support of overlying devices.

The first insulator layer 103 may be a dielectric layer that separates the first substrate 101 from the overlying first active layer 401 and can additionally, in some embodiments, serve as a portion of cladding material that surrounds the subsequently manufactured first optical components 403 (discussed further below). In an embodiment the first insulator layer 103 may be silicon oxide, silicon nitride, germanium oxide, germanium nitride, combinations of these, or the like, formed using a method such as implantation (e.g., to form a buried oxide (BOX) layer) or else may be deposited onto the first substrate 101 using a deposition method such as chemical vapor deposition, atomic layer deposition, physical vapor deposition, combinations of these, or the like. However, any suitable material and method of manufacture may be used.

The material 105 for the first active layer 401 is initially (prior to patterning) a conformal layer of material that will be used to begin manufacturing the first active layer 401 of the first optical components 403. In an embodiment the material 105 for the first active layer 401 may be a translucent material that can be used as a core material for the desired first optical components 403, such as a semiconductor material such as silicon (with, e.g., a refractive index close to 3.3), germanium, silicon germanium, combinations of these, or the like, while in other embodiments the material 105 for the first active layer 401 may be a dielectric material such as silicon nitride or the like, although in other embodiments the material 105 for the first active layer 401 may be III-V materials, lithium niobate materials, or polymers. In embodiments in which the material 105 of the first active layer 401 is deposited, the material 105 for the first active layer 401 may be deposited using a method such as epitaxial growth, chemical vapor deposition, atomic layer deposition, physical vapor deposition, combinations of these, or the like. In other embodiments in which the first insulator layer 103 is formed using an implantation method, the material 105 of the first active layer 401 may initially be part of the first substrate 101 prior to the implantation process to form the first insulation layer 103. However, any suitable materials and methods of manufacture may be utilized to form the material 105 of the first active layer 401.

In order to prepare the material 105 for patterning, a photosensitive layer 107 may be placed over the material 105 prior to imaging. In an embodiment the photosensitive layer 107 may be, e.g., a tri-layer photoresist, with a bottom anti-reflective layer, a middle layer, and a top photoresist layer. However, any suitable layer or combination of layers may be utilized.

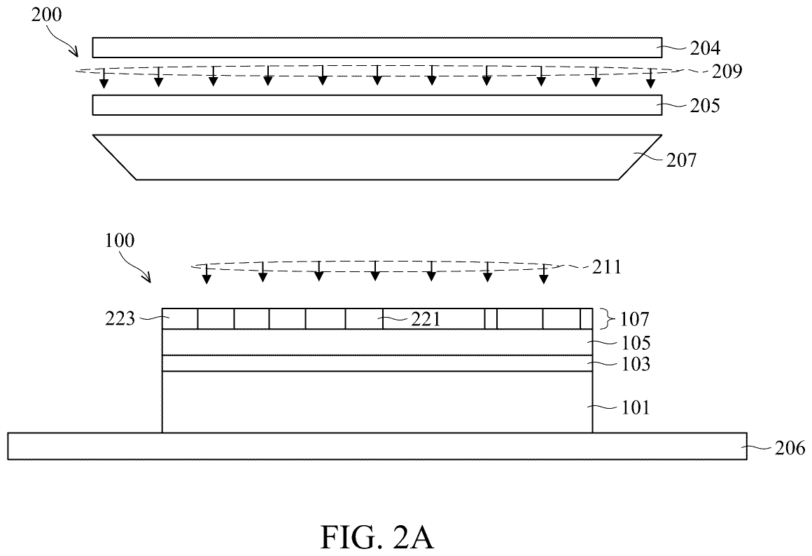

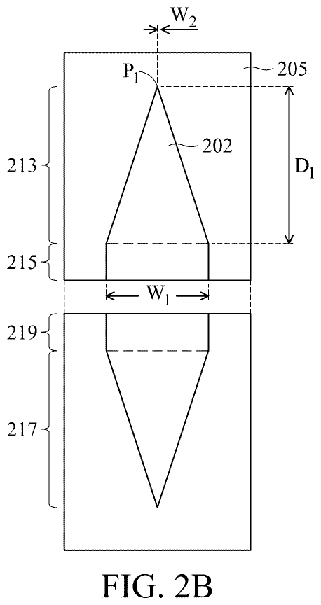

FIG. 2A illustrates that, once the material 105 and the photosensitive layer 107 are ready, the photosensitive layer 107 may be imaged to prepare to form the first optical components 403 for the first active layer 401. In embodiments the first optical components 403 of the first active layer 401 may include such components as optical waveguides (e.g., ridge waveguides, rib waveguides, buried channel waveguides, diffused waveguides, etc.), couplers (e.g., grating couplers, edge couplers that are a narrowed waveguide with a width of between about 1 nm and about 200 nm, etc.), directional couplers, optical modulators (e.g., Mach-Zehnder silicon-photonic switches, microelectromechanical switches, micro-ring resonators, etc.), amplifiers, multiplexors, demultiplexors, optical-to-electrical converters (e.g., P-N junctions), electrical-to-optical converters, lasers, combinations of these, or the like. However, any suitable first optical components 403 may be used.

In a particular embodiment, once the photosensitive layer 107 has been applied, the photosensitive layer 107 may be exposed to form an exposed region 223 and an unexposed region 221 within the photosensitive layer 107. In an embodiment the exposure may be initiated by placing the first substrate 101 and the photosensitive layer 107, once cured and dried, into a photoresist imaging device 200 for exposure. The photoresist imaging device 200 may comprise a photoresist support plate 206, a photoresist energy source 204, a patterned mask 205 between the photoresist support plate 206 and the photoresist energy source 204, and photoresist optics 207. In an embodiment the photoresist support plate 206 is a surface to which the first substrate 101 and the photosensitive layer 107 may be placed or attached to and which provides support and control to the first substrate 101 during exposure of the photosensitive layer 107. Additionally, the photoresist support plate 206 may be movable along one or more axes, as well as providing any desired heating or cooling to the first substrate 101 and photosensitive layer 107 in order to prevent temperature gradients from affecting the exposure process.

In an embodiment the photoresist energy source 204 supplies photoresist energy 209 such as light to the photosensitive layer 107 in order to induce a reaction within the photosensitive layer 107, which in turn chemically alters those portions of the photosensitive layer 107 to which the photoresist energy 209 impinges. In an embodiment the photoresist energy 209 may be electromagnetic radiation, such as a deep ultraviolet (DUV) light, an extreme ultraviolet (EUV) light, g-rays (with a wavelength of about 436 nm), i-rays (with a wavelength of about 365 nm), ultraviolet radiation, far ultraviolet radiation, x-rays, electron beams, or the like. The photoresist energy source 204 may be a source of the electromagnetic radiation, KrF excimer laser light (with a wavelength of 248 nm), an ArF excimer laser light (with a wavelength of 193 nm), a F2 excimer laser light (with a wavelength of 157 nm), or the like, although any other suitable source of photoresist energy 209, such as mercury vapor lamps, xenon lamps, carbon arc lamps or the like, may alternatively be utilized. Any exposure wavelength may be used, such as between 10 nm and 450 nm, and all are fully intended to be included within the scope of the embodiments.

The patterned mask 205 is located between the photoresist energy source 204 and the photosensitive layer 107 in order to block portions of the photoresist energy 209 to form a patterned energy 211 prior to the photoresist energy 209 actually impinging upon the photosensitive layer 107. In an embodiment the patterned mask 205 may comprise a series of layers (e.g., substrate, absorbance layers, anti-reflective coating layers, shielding layers, etc.) to reflect, absorb, or otherwise block portions of the photoresist energy 209 from reaching those portions of the photosensitive layer 107 which are not desired to be illuminated. The desired pattern may be formed in the patterned mask 205 by forming openings through the patterned mask 205 in the desired shape of illumination, such as through one or more masking and etching processes.

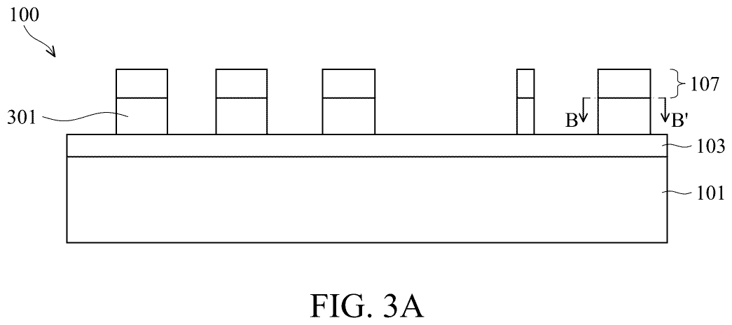

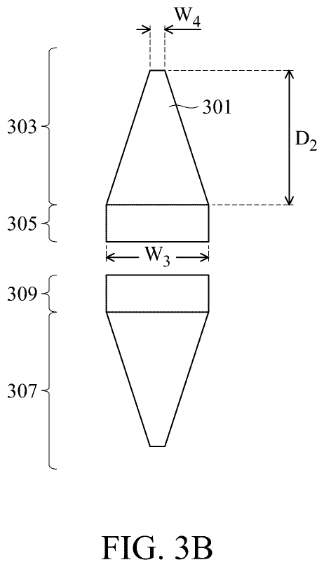

FIG. 2B illustrates a close up, top down view of one pattern (e.g., opening 202) within the patterned mask 205 that may be used to help form a first waveguide 301 (not illustrated in FIG. 2B but illustrated and seen in FIG. 3B below). In particular, FIG. 2B illustrates two ends of the desired first waveguide 301, with the intervening portions represented by the dashed box between the two ends. As can be seen in this top down view, only one of the layers of the patterned mask 205 is visible and works to block and/or reflect light, while only allowing light to go through the patterned mask 205 in the desired shape.

Looking at the opening 202 through the patterned mask 205 for the first waveguide 301, the opening may have a first tapered mask portion 213 and a first transmission mask portion 215 at a first end of the opening 202. Looking first at the first transmission mask portion 215, the first transmission mask portion 215 may be sized and shaped to pattern core material within the subsequently formed first waveguide 301 to contain and direct optical signals. In a particular embodiment the first transmission mask portion 215 may be rectangular in shape as it extends from the first tapered mask portion 213, and may have a first width W₁ of between about 0.5 μm and about 5 μm. However, any suitable size and shape may be utilized.

Looking next at the first tapered mask portion 213, the first tapered mask portion 213 extends away from the first transmission mask portion 215 in order to help pattern the first waveguide 301. In an embodiment the first tapered mask portion 213 tapers from the first width W₁ to a first point P₁ over a first distance D₁. In an embodiment the first distance D₁ may be between about 50 μm and about 400 μm. However, any suitable dimensions may be utilized.

Additionally, the first point P₁, while theoretically going down to a width of zero, will actually have a second width W₂ that is very small. In some embodiments the second width W₂ will have a width that is so small that, once the patterned energy 211 is patterned by the patterned mask 205 and reduced by, e.g., the photoresist optics 207 (e.g., reduced by an amount of 5 to 1, 3 to 1, or 2 to 1, etc.), the patterned energy 211 will form an image of no greater than about 100 nm.

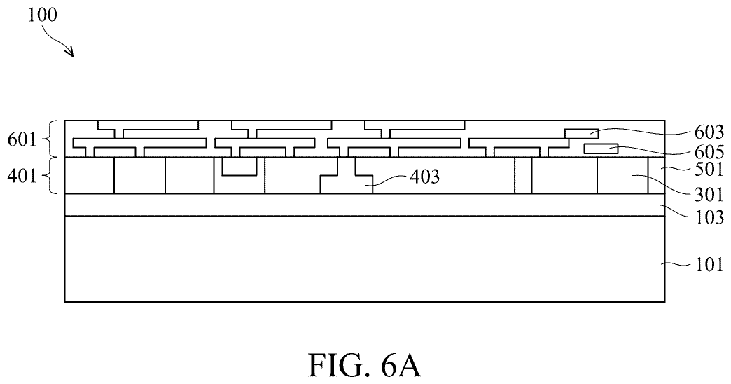

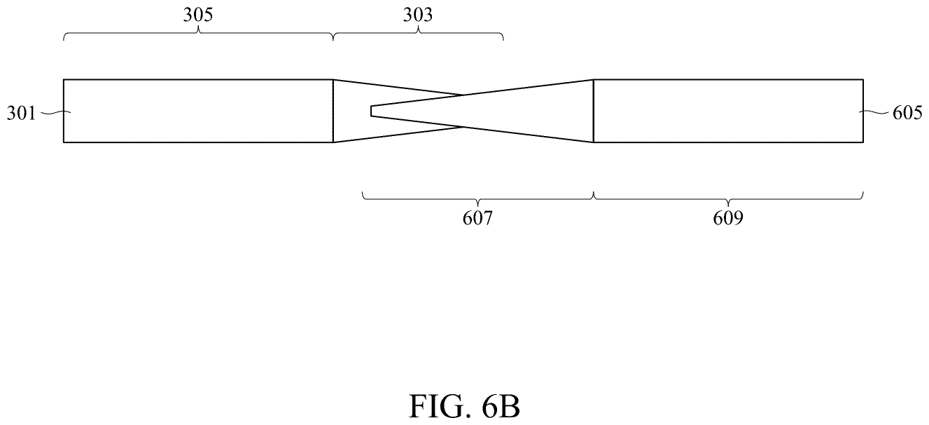

By using the first tapered mask portion 213 to pattern the first waveguide 301, the first tapered mask portion 213 helps assist the first waveguide 301 transmit optical signals to a second waveguide 605 (not illustrated in FIG. 2B but illustrated and discussed below with respect to FIG. 6B). Additionally, by using the patterned mask 205 with the second width W₂ at the first point P₁, the effective refractive index of the subsequently formed first waveguide 301 can be further reduced, thus further diminishing the confinement of optical signals in the first waveguide 301.

At another end of the pattern for the first waveguide 301, there is a second tapered mask portion 217 and a second transmission mask portion 219. In an embodiment the second tapered mask portion 217 and the second transmission mask portion 219 may be patterns similar to the first tapered mask portion 213 and the first transmission mask portion 215. However, any suitable shape or dimensions may be utilized.

Returning now to FIG. 2A, optics (represented in FIG. 2A by the trapezoid labeled 207) may be used to reduce, expand, reflect, or otherwise control the photoresist energy 209 as it leaves the photoresist energy source 204, is patterned by the patterned mask 205, and is directed towards the photosensitive layer 107. In an embodiment the photoresist optics 207 comprise one or more lenses, mirrors, filters, combinations of these, or the like to control the photoresist energy 209 along its path. Additionally, while the photoresist optics 207 are illustrated in FIG. 2A as being between the patterned mask 205 and the photosensitive layer 107, elements of the photoresist optics 207 (e.g., individual lenses, mirrors, etc.) may also be located at any location between the photoresist energy source 204 (where the photoresist energy 209 is generated) and the photosensitive layer 107.

In an embodiment the first substrate 101 with the photosensitive layer 107 is placed on the photoresist support plate 206. Once the pattern has been aligned, the photoresist energy source 204 generates the desired photoresist energy 209 (e.g., light) which passes through the patterned mask 205 and the photoresist optics 207 on its way to the photosensitive layer 107. The patterned energy 211 impinging upon portions of the photosensitive layer 107 induces a reaction within the photosensitive layer 107. The chemical reaction chemically alters the photosensitive layer 107 in those portions that were illuminated through the patterned mask 205.

Optionally, the exposure of the photosensitive layer 107 may occur using an immersion lithography technique. In such a technique an immersion medium (not individually illustrated in FIG. 2A) may be placed between the photoresist imaging device 200 (and particularly between a final lens of the photoresist optics 207) and the photosensitive layer 107. With this immersion medium in place, the photosensitive layer 107 may be patterned with the patterned energy 211 passing through the immersion medium.

FIG. 3A illustrates a development of the photosensitive layer 107 with the use of a developer (not separately illustrated in FIG. 3A) after the photosensitive layer 107 has been exposed. After the photosensitive layer 107 has been exposed and the post-exposure baking has occurred, the photosensitive layer 107 may be developed using either a positive tone developer or a negative tone developer, depending upon the desired pattern for the photosensitive layer 107.

FIG. 3A additionally illustrates that, once the photosensitive elements within the photosensitive layer 107 have been developed, the pattern of the photosensitive elements may be extended through a remainder of the photosensitive layer 107 and through the material 105 to expose the underlying first insulation layer 103. In an embodiment the extension may be performed using one or more anisotropic etching processes, such as one or more reactive ion etching processes. However, any suitable processes may be utilized.

At some point during the extension of the pattern, either between two of the one or more etching processes or after the extension has been completed, the photosensitive layer 107 may be removed. In an embodiment the photosensitive layer 107 may be removed using one or more processes such as ashing, etching, combinations of these, or the like. However, any suitable removal process may be utilized.

FIG. 3B illustrates a close up, top down view of the first waveguide 301 (along line B-B′) formed within the first active layer 401 as one of the first optical components 403. In particular, FIG. 3B illustrates two ends of the desired first waveguide 301, with the intervening portions represented by the dashed box between the two ends. As can be seen in this top down view of FIG. 3B, the material 105 has been patterned into the desired shape for the first waveguide 301.

In an embodiment, the first waveguide 301 may have a first tapered portion 303 and a first transmission portion 305 at a first end of the first waveguide 301. Looking first at the first transmission portion 305, the first transmission portion 305 may be sized and shaped to contain and direct optical signals through the first waveguide 301. In a particular embodiment the first transmission portion 305 may be rectangular in shape as it extends from the first tapered portion 303, and may have a third width W₃ of between about 500 nm and about 200 nm. However, any suitable size and shape may be utilized.

Looking next at the first tapered portion 303, the first tapered portion 303 extends away from the first transmission portion 305. In an embodiment the first tapered portion 303 tapers from the third width W₃ to a fourth width W₄ at a second side of the first tapered portion 303 over a second distance D₂. In an embodiment the second distance D₂ of between about 50 μm and about 400 μm. However, any suitable dimensions may be utilized.

Taking a closer look at the second side of the first tapered portion 303 opposite the first transmission portion 305, the second side may not extend to a point like the pattern of the first waveguide 301 in the patterned mask 205 (discussed above with respect to FIG. 2B). For example, because the transfer of the pattern is not as complete as the size of the pattern becomes smaller and smaller and runs up against different limitations, the second side of the first tapered portion 303 may have a different shape from the first point P₁, such as being a line which extends from one tapered side to a second tapered side. In an embodiment the line with the different shape may have the fourth width W₄ of between about 50 nm and about 200 nm, such as less than about 100 nm, less than 50 nm, or even less than 10 nm, so that the third width W₃ is between five times and 20 times greater than the fourth width W₄. However, any suitable dimensions may be utilized.

By using the first tapered portion 303 within the first waveguide 301, the correlation between the actual mask linewidth in the patterned mask 205 and the linewidth achieved in the first waveguide 301 may be mitigated and the requirements for a linewidth defined patterning process may be released. As such, the narrower first tapered portion 303 helps assist the first waveguide 301 transmit optical signals to a second waveguide 605 (not illustrated in FIG. 3B but illustrated and discussed below with respect to FIG. 6B). Additionally, by using the patterned mask 205 with the second width W₂ at the first point P₁, the fourth width W₄ of the first waveguide 301 can be further reduced, thereby lowering the effective refractive index of the first waveguide 301. As such, the confinement of optical signals in the first waveguide 301 can be reduced in the first tapered portion 303, allowing for a better transfer of the optical signals to the second waveguide 605.

At another end of first waveguide 301, there is a second tapered portion 307 and a second transmission portion 309. In an embodiment the second tapered portion 307 and the second transmission portion 309 may be patterns similar to the first tapered portion 303 and the first transmission portion 305. However, any suitable shape or dimensions may be utilized.

Of course, while one possible imaging process has been described above, these described processes are intended to be illustrative and are not intended to limit the embodiments to the precise descriptions presented. Rather, any suitable process, such as an e-beam process, may be utilized. All such processes are fully intended to be included within the scope of the embodiments.

FIG. 4 illustrates that, for those components that utilize further manufacturing processes, such as Mach-Zehnder silicon-photonic switches that utilize resistive heating elements, additional processing may be performed either before or after the patterning of the material for the first active layer 401. For example, implantation processes, additional deposition and patterning processes for different materials (e.g., resistive heating elements, III-V materials for converters), combinations of all of these processes, or the like, can be utilized to help further the manufacturing of the various desired first optical components 403. In a particular embodiment, and as specifically illustrated in FIG. 4, in some embodiments an epitaxial deposition of a semiconductor material 405 such as germanium (used, e.g., for electricity/optics signal modulation and transversion) may be performed on a patterned portion of the material 105 of the first active layer 401. In such an embodiment the semiconductor material 405 may be epitaxially grown in order to help manufacture, e.g., a photodiode for an optical-to-electrical converter. All such manufacturing processes and all suitable first optical components 403 may be manufactured, and all such combinations are fully intended to be included within the scope of the embodiments.

FIG. 5 illustrates that, once the individual first optical components 403 of the first active layer 401 have been formed, a second insulator layer 501 may be deposited to cover the first optical components 403 and provide additional cladding material. In an embodiment the second insulator layer 501 may be a dielectric layer that separates the individual components of the first active layer 401 from each other and from the overlying structures and can additionally serve as another portion of cladding material that surrounds the first optical components 403. In an embodiment the second insulator layer 501 may be silicon oxide, silicon nitride, germanium oxide, germanium nitride, combinations of these, or the like, formed using a deposition method such as chemical vapor deposition, atomic layer deposition, physical vapor deposition, combinations of these, or the like. Once the material of the second insulator layer 501 has been deposited, the material may be planarized using, e.g., a chemical mechanical polishing process in order to either planarize a top surface of the second insulator layer 501 (in embodiments in which the second insulator layer 501 is intended to fully cover the first optical components 403) or else planarize the second insulator layer 501 with top surfaces of the first optical components 403. However, any suitable material and method of manufacture may be used.

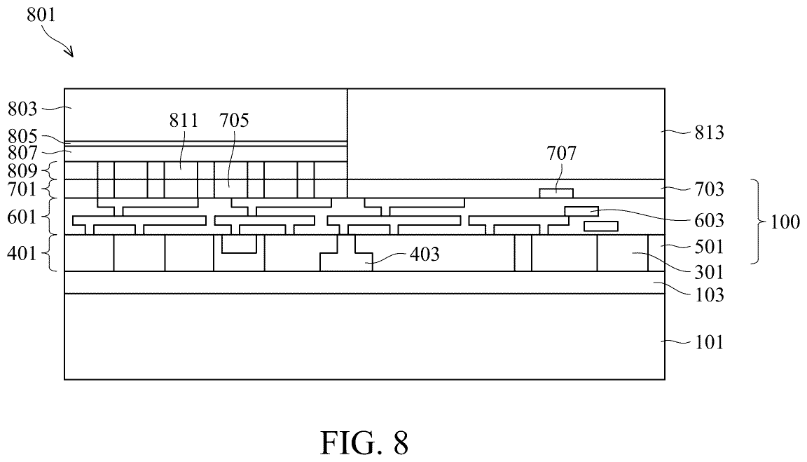

FIG. 6A illustrates that, once the first optical components 403 of the first active layer 401 have been manufactured and the second insulator layer 501 has been formed, first metallization layers 601 are formed in order to electrically connect the first active layer 401 of first optical components 403 to control circuitry, to each other, and to subsequently attached devices (not illustrated in FIG. 6A but illustrated and described further below with respect to FIG. 8). In an embodiment the first metallization layers 601 are formed of alternating layers of dielectric and conductive material and may be formed through any suitable processes (such as deposition, damascene, dual damascene, etc.). In particular embodiments there may be multiple layers of metallization used to interconnect the various first optical components 403, but the precise number of first metallization layers 601 is dependent upon the design of the optical interposer 100.

Additionally, during the manufacture of the first metallization layers 601, one or more second optical components 603 may be formed as part of the first metallization layers 601. In some embodiments the second optical components 603 of the first metallization layers 601 may include such components as optical waveguides (e.g., ridge waveguides, rib waveguides, buried channel waveguides, diffused waveguides, etc.), couplers (e.g., edge couplers, grating couplers, etc.) for connection to outside signals, optical modulators (e.g., Mach-Zehnder silicon-photonic switches, microelectromechanical switches, micro-ring resonators, etc.), amplifiers, multiplexors, demultiplexors, optical-to-electrical converters (e.g., P-N junctions), electrical-to-optical converters, lasers, combinations of these, or the like. However, any suitable optical components may be used for the one or more second optical components 603.

In an embodiment the one or more second optical components 603 may be formed by initially depositing a material for the one or more second optical components 603. In an embodiment the material for the one or more second optical components 603 may be a dielectric material such as silicon nitride, silicon oxide, combinations of these, or the like, or a semiconductor material such as silicon, or other materials such as lithium niobate or aluminum oxide. These materials may be deposited using a deposition method such as chemical vapor deposition, atomic layer deposition, physical vapor deposition, combinations of these, or the like. However, any suitable material and any suitable method of deposition may be utilized.

Once the material for the one or more second optical components 603 has been deposited or otherwise formed, the material may be patterned into the desired shapes for the one or more second optical components 603. In an embodiment the material of the one or more second optical components 603 may be patterned using, e.g., the processes described above with respect to FIGS. 1-4. However, any suitable method of patterning the material for the one or more second optical components 603 may be utilized.

For some of the one or more second optical components 603, such as waveguides or edge couplers, the patterning process may be all or at least most manufacturing that is used to form these components. Additionally, for those components that utilize further manufacturing processes, such as Mach-Zehnder silicon-photonic switches that utilize resistive heating elements, additional processing may be performed either before or after the patterning of the material for the one or more second optical components 603. For example, implantation processes, additional deposition and patterning processes for different materials, combinations of all of these processes, or the like, and can be utilized to help further the manufacturing of the various desired one or more second optical components 603. All such manufacturing processes and all suitable one or more second optical components 603 may be manufactured, and all such combinations are fully intended to be included within the scope of the embodiments.

FIG. 6B illustrates a top down view of a portion of a second waveguide 605 formed as one of the second optical components 603 overlying a portion of the first waveguide 301 (discussed above with respect to FIG. 3B). In this embodiment the second waveguide 605 may be formed using similar processes as described above with respect to FIG. 3B, and may comprise a third tapering portion 607 (similar to the first tapering portion 303) and a third transmission portion 609 (similar to the first transmission portion 305—both of which extend to different portions of the device but which are illustrated as short in FIG. 6B for clarity).

In an embodiment the third tapering portion 607 of the second waveguide 605 may (similar to the first tapering portion 303) have a straight portion with a different shape than the mask used to help pattern the material of the second waveguide 605. In other embodiments the third tapering portion 607 may have a same shape as the mask used to help pattern the material of the second waveguide 605 (e.g., the mask has a straight side instead of a point). Any suitable combination may be utilized.

Both the first waveguide 301 and the second waveguide 605 are located so that the third tapering portion 607 of the second waveguide 605 directly overlies the first tapering portion 303 of the first waveguide 301 so that, in operation, optical signals will transit from the first waveguide 301 to the second waveguide 605 (in the overlying layer) by entering the first tapering portion 303, where the reduction in the lateral dimension of the first waveguide 301 through the first tapered portion 303 reduces the effective refractive index of the first waveguide 301, thus diminishing the confinement of the optical signals within the first waveguide 301. When the effective refractive index of the first waveguide 301 is matched to the effective refractive index of the second waveguide 605, the optical signals will seamlessly transfer between the first waveguide 301 and the second waveguide 605. In some embodiments, the optical signals are transferred to the dielectric/cladding material of the first metallization layer 601 between the first waveguide 301 and the second waveguide 605 and then the optical signals are transferred from the dielectric/cladding to the second waveguide 605.

In particular embodiments in which the fourth width W₄ is about 100 nm for each of the first waveguide 301 and the second waveguide 605, a transference of optical signals of about 97.79% is estimated to be obtained. In other embodiments in which the fourth width W₄ is about 50 nm for each of the first waveguide 301 and the second waveguide 605, a transference of optical signals of about 99.6594% is estimated to be obtained. However, any suitable widths may be utilized.

FIG. 7 illustrates that, once the one or more second optical components 603 of the first metallization layers 601 have been manufactured, a first bonding layer 701 is formed over the first metallization layers 601. In an embodiment, the first bonding layer 701 may be used for a dielectric-to-dielectric and metal-to-metal bond. In accordance with some embodiments, the first bonding layer 701 is formed of a first dielectric material 703 such as silicon oxide, silicon nitride, or the like. The first dielectric material 703 may be deposited using any suitable method, such as CVD, high-density plasma chemical vapor deposition (HDPCVD), PVD, atomic layer deposition (ALD), or the like. However, any suitable materials and deposition processes may be utilized.

Once the first dielectric material 703 has been formed, first openings in the first dielectric material 703 are formed to expose conductive portions of the underlying layers in preparation to form first bond pads 705 within the first bonding layer 701. Once the first openings have been formed within the first dielectric material 703, the first openings may be filled with a seed layer and a plate metal to form the first bond pads 705 within the first dielectric material 703. The seed layer may be blanket deposited over top surfaces of the first dielectric material 703 and the exposed conductive portions of the underlying layers and sidewalls of the openings and the second openings. The seed layer may comprise a copper layer. The seed layer may be deposited using processes such as sputtering, evaporation, or plasma-enhanced chemical vapor deposition (PECVD), or the like, depending upon the desired materials. The plate metal may be deposited over the seed layer through a plating process such as electrical or electro-less plating. The plate metal may comprise copper, a copper alloy, or the like. The plate metal may be a fill material. A barrier layer (not separately illustrated) may be blanket deposited over top surfaces of the first dielectric material 703 and sidewalls of the openings and the second openings before the seed layer. The barrier layer may comprise titanium, titanium nitride, tantalum, tantalum nitride, or the like.

Following the filling of the first openings, a planarization process, such as a CMP, is performed to remove excess portions of the seed layer and the plate metal, forming the first bond pads 705 within the first bonding layer 701. In some embodiments a bond pad via (not separately illustrated) may also be utilized to connect the first bond pads 705 with underlying conductive portions and, through the underlying conductive portions, connect the first bond pads 705 with the first metallization layers 601.

Additionally, the first bonding layer 701 may also include one or more third optical components 707 incorporated within the first bonding layer 701. In such an embodiment, prior to the deposition of the first dielectric material 703, the one or more third optical components 707 may be manufactured using similar methods and similar materials as the one or more second optical components 603 (described above), such as by being waveguides and other structures formed at least in part through a deposition and patterning process. However, any suitable structures, materials and any suitable methods of manufacture may be utilized.

FIG. 8 illustrates a bonding of a first semiconductor device 801 to the first bonding layer 701 of the optical interposer 100. In some embodiments, the first semiconductor device 801 is an electronic integrated circuit (EIC—e.g., a device without optical devices) and may have a semiconductor substrate 803, a layer of active devices 805, an overlying interconnect structure 807, a second bonding layer 809, and associated third bond pads 811. In an embodiment the semiconductor substrate 803 may be similar to the first substrate 101 (e.g., a semiconductor material such as silicon or silicon germanium), the active devices 805 may be transistors, capacitors, resistors, and the like formed over the semiconductor substrate 803, the interconnect structure 807 may be similar to the first metallization layers 601 (without optical components), the second bonding layer 809 may be similar to the first bonding layer 701, and the third bond pads 811 may be similar to the first bond pads 705. However, any suitable devices may be utilized.

In an embodiment the first semiconductor device 801 may be configured to work with the optical interposer 100 for a desired functionality. In some embodiments the first semiconductor device 801 may be a high bandwidth memory (HBM) module, an xPU, a logic die, a 3DIC die, a CPU, a GPU, a SoC die, a MEMS die, combinations of these, or the like. Any suitable device with any suitable functionality, may be used, and all such devices are fully intended to be included within the scope of the embodiments.

In an embodiment the first semiconductor device 801 and the first bonding layer 701 may be bonded using a dielectric-to-dielectric and metal-to-metal bonding process. In a particular embodiment which utilizes a dielectric-to-dielectric and metal-to-metal bonding process, the process may be initiated by activating the surfaces of the second bonding layer 809 and the surfaces of the first bonding layer 701. Activating the top surfaces of the first bonding layer 701 and the second bonding layer 809 may comprise a dry treatment, a wet treatment, a plasma treatment, exposure to an inert gas plasma, exposure to H₂, exposure to N₂, exposure to O₂, combinations thereof, or the like, as examples. In embodiments where a wet treatment is used, an RCA cleaning may be used, for example. In another embodiment, the activation process may comprise other types of treatments. The activation process assists in the bonding of the first bonding layer 701 and the second bonding layer 809.

After the activation process the optical interposer 100 and the first semiconductor device 801 may be cleaned using, e.g., a chemical rinse, and then the first semiconductor device 801 is aligned and placed into physical contact with the optical interposer 100. The optical interposer 100 and the first semiconductor device 801 are then subjected to thermal treatment and contact pressure to bond the optical interposer 100 and the first semiconductor device 801. For example, the optical interposer 100 and the first semiconductor device 801 may be subjected to a pressure of about 200 kPa or less, and a temperature between about 25° C. and about 250° C. to fuse the optical interposer 100 and the first semiconductor device 801. The optical interposer 100 and the first semiconductor device 801 may then be subjected to a temperature at or above the eutectic point for material of the first bond pads 705 and the third bond pads 811, e.g., between about 150° C. and about 650° C., to fuse the metal. In this manner, the optical interposer 100 and the first semiconductor device 801 forms a dielectric-to-dielectric and metal-to-metal bonded device. In some embodiments, the bonded dies are subsequently baked, annealed, pressed, or otherwise treated to strengthen or finalize the bond.

Additionally, while specific processes have been described to initiate and strengthen the bonds, these descriptions are intended to be illustrative and are not intended to be limiting upon the embodiments. Rather, any suitable combination of baking, annealing, pressing, or combination of processes may be utilized. All such processes are fully intended to be included within the scope of the embodiments.

FIG. 8 additionally illustrates that, once the first semiconductor device 801 has been bonded, a first gap-fill material 813 is deposited in order to fill the space around the first semiconductor device 801 and provide additional support. In an embodiment the first gap-fill material 813 may be a material such as silicon oxide, silicon nitride, silicon oxynitride, combinations of these, or the like, deposited to fill and overfill the spaces around the first semiconductor device 801. However, any suitable material and method of deposition may be utilized.

Once the first gap-fill material 813 has been deposited, the first gap-fill material 813 may be planarized in order to expose the first semiconductor device 801. In an embodiment the planarization process may be a chemical mechanical planarization process, a grinding process, or the like. However, any suitable planarization process may be utilized.

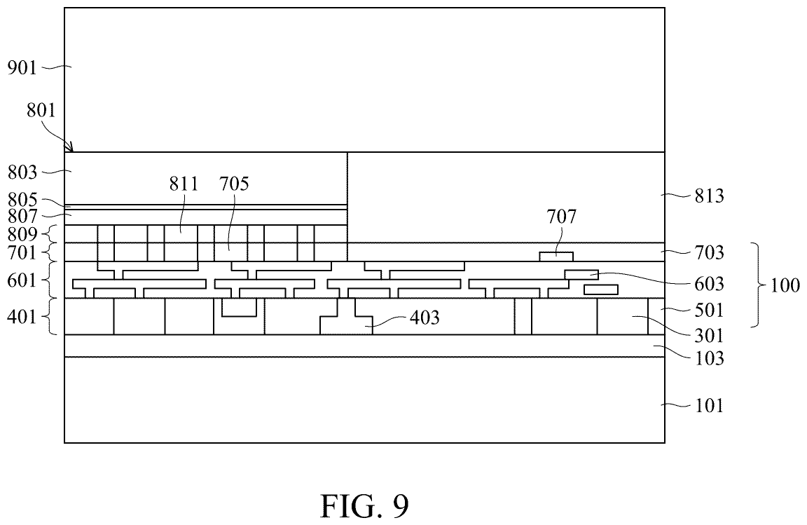

FIG. 9 illustrates an attachment of a first support substrate 901 to the first semiconductor device 801 and the first gap-fill material 813. In an embodiment the first support substrate 901 may be a support material that is transparent to the wavelength of light that is desired to be used, such as silicon, and may be attached using, e.g., an adhesive (not separately illustrated in FIG. 9). However, in other embodiments the first support substrate 901 may be bonded to the first semiconductor device 801 and the first gap-fill material 813 using, e.g., a bonding process. Any suitable method of attaching the first support substrate 901 may be used.

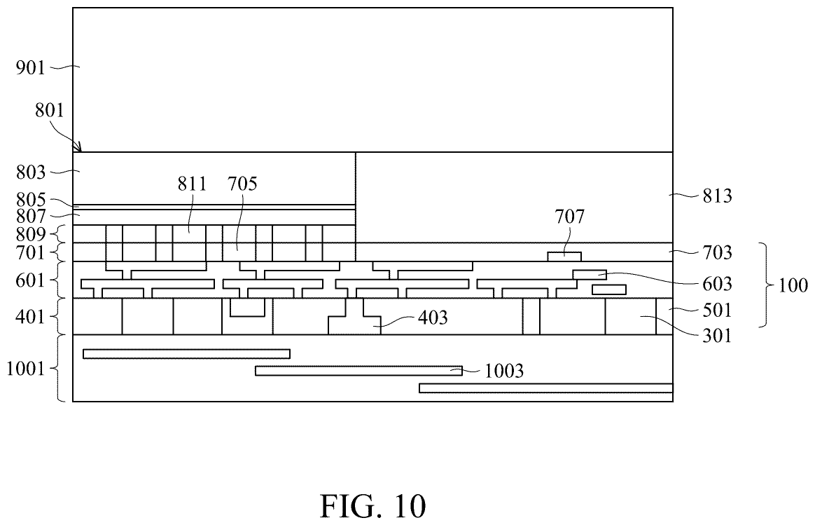

FIG. 10 illustrates a removal of the first substrate 101 and, optionally, the first insulator layer 103, thereby exposing the first active layer 401 of first optical components 403. In an embodiment the first substrate 101 and the first insulator layer 103 may be removed using a planarization process, such as a chemical mechanical polishing process, a grinding process, one or more etching processes, combinations of these, or the like. However, any suitable method may be used in order to remove the first substrate 101 and/or the first insulator layer 103.

Once the first substrate 101 and the first insulator layer 103 have been removed, a second active layer 1001 of fourth optical components 1003 may be formed on a back side of the first active layer 401. In an embodiment the second active layer 1001 of fourth optical components 1003 may be formed using similar materials and similar processes as the second optical components 603 of the first metallization layers 601 (described above with respect to FIG. 6). For example, the second active layer 1001 of fourth optical components 1003 may be formed of alternating layers of a cladding material such as silicon oxide and core material such as silicon nitride formed using deposition and patterning processes in order to form optical components such as waveguides and the like.

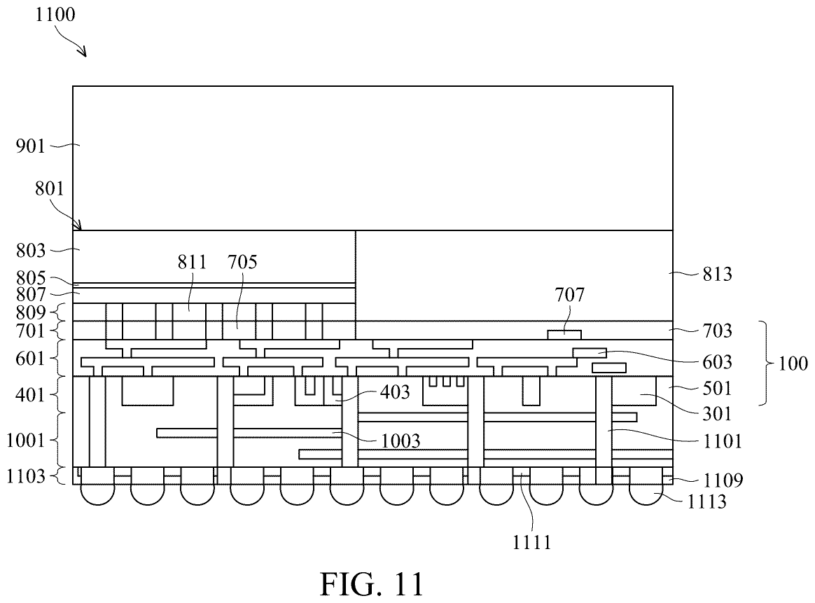

FIG. 11 illustrates formation of first through device vias (TDVs) 1101 and formation of a third bonding layer 1103 to form a first optical package 1100 which, in some embodiments is a compact universal photonic engine (COUPE). In an embodiment the first through device vias 1101 extend through the second active layer 1001 and the first active layer 401 so as to provide a quick passage of power, data, and ground through the optical interposer 100. In an embodiment the first through device vias 1101 may be formed by initially forming through device via openings into the optical interposer 100. The through device via openings may be formed by applying and developing a suitable photoresist (not shown), and removing portions of the second active layer 1001 and the optical interposer 100 that are exposed.

Once the through device via openings have been formed within the optical interposer 100, the through device via openings may be lined with a liner. The liner may be, e.g., an oxide formed from tetraethylorthosilicate (TEOS) or silicon nitride, although any suitable dielectric material may alternatively be used. The liner may be formed using a plasma enhanced chemical vapor deposition (PECVD) process, although other suitable processes, such as physical vapor deposition or a thermal process, may also be used.

Once the liner has been formed along the sidewalls and bottom of the through device via openings, a barrier layer (also not independently illustrated) may be formed and the remainder of the through device via openings may be filled with first conductive material. The first conductive material may comprise copper, although other suitable materials such as aluminum, alloys, doped polysilicon, combinations thereof, and the like, may be utilized. The first conductive material may be formed by electroplating copper onto a seed layer (not shown), filling and overfilling the through device via openings. Once the through device via openings have been filled, excess liner, barrier layer, seed layer, and first conductive material outside of the through device via openings may be removed through a planarization process such as chemical mechanical polishing (CMP), although any suitable removal process may be used.

Optionally, in some embodiments once the first through device vias 1101 have been formed, second metallization layers (not separately illustrated in FIG. 11) may be formed in electrical connection with the first through device vias 1101. In an embodiment the second metallization layers may be formed as described above with respect to the first metallization layers 601, such as being alternating layers of dielectric and conductive materials using damascene processes, dual damascene process, or the like. In other embodiments, the second metallization layers may be formed using a plating process to form and shape conductive material, and then cover the conductive material with a dielectric material. However, any suitable structures and methods of manufacture may be utilized.

The third bonding layer 1103 is formed in order to provide electrical connections between the optical interposer 100 and subsequently attached devices. In an embodiment the third bonding layer 1103 may be similar to the first bonding layer 701, such as having third bond pads 1109 (similar to the first bond pads 705) and even fifth optical components 1111 (similar to the third optical components 707). However, any suitable devices may be utilized.

FIG. 11 additionally illustrates a placement of first external connectors 1113 which may be formed to provide conductive regions for contact between the third bond pads 1109 to other external devices. The first external connectors 1113 may be conductive bumps (e.g., C4 bumps, ball grid arrays, microbumps, etc.) or conductive pillars utilizing materials such as solder and copper. In an embodiment in which the first external connectors 1113 are contact bumps, the first external connectors 1113 may comprise a material such as tin, or other suitable materials, such as silver, lead-free tin, or copper. In an embodiment in which the first external connectors 1113 are tin solder bumps, the first external connectors 1113 may be formed by initially forming a layer of tin through such commonly used methods such as evaporation, electroplating, printing, solder transfer, ball placement, etc. Once a layer of tin has been formed on the structure, a reflow may be performed in order to shape the material into the desired bump shape.

Of course, while the use of first external connectors 1113 is one embodiment which may be used in order to provide connections for the first optical package 1100, this is intended to be illustrative and is not intended to limit the embodiments. Rather, any suitable method of physically, electrically, and in some cases optically connecting the first optical package 1100, such as dielectric-to-dielectric and metal-to-metal bonding, may also be utilized. Any suitable method of bonding the first optical package 1100 may be used.

By utilizing the above described processes, the limitations of coupling capabilities between two heterogeneous waveguides with large refractive index differences can be ameliorated at least in part by overcoming patterning linewidth limitations imposed by the capabilities of the photolithography used in the patterning process. In particular, as smaller linewidths are pursued, the above described process helps to break the conventional definition of mask the transferring methodology.

In an embodiment, a method of manufacturing an optical device, the method including: placing a substrate on a platform inside an optical imaging device, the optical imaging device comprising a first mask, the first mask having a first opening with a first tapered mask portion having a first shape; using the first mask to image a photosensitive layer and form a photomask; and using the photomask to pattern a core material into a first waveguide, the first waveguide having a first tapered portion corresponding to the first tapered mask portion, the first tapered portion having a second shape different from the first shape. In an embodiment the second shape comprises a first side with a length that is no greater than about 100 nm. In an embodiment the using the first mask to image the photosensitive layer uses extreme ultraviolet light. In an embodiment the using the first mask to image the photosensitive layer uses deep ultraviolet light. In an embodiment the core material comprises aluminum oxide. In an embodiment the core material comprises lithium niobate. In an embodiment the method further includes forming a second waveguide over the substrate, the second waveguide comprising a second tapered portion directly overlying the first tapered portion.

In another embodiment, a method of manufacturing an optical device, the method including: forming a first waveguide over a substrate, the first waveguide comprising a first tapered portion with a first width and a second width, the first width being at least five times greater than the second width; and forming a second waveguide over the substrate, the second waveguide comprising a second tapered portion, the second tapered portion being located directly over the first tapered portion. In an embodiment the forming the first waveguide includes: placing a first mask into an optical imaging device, the first mask comprising a first opening for a first tapered mask portion with a first side and a second side extending to a first tip; placing the substrate into the optical imaging device; patterning an energy source through the first mask to form a patterned energy source; and using the patterned energy source to form the first waveguide, wherein the first waveguide comprises a third side corresponding to the first side, a fourth side corresponding to the second side, and a fifth side extending from the third side to the fourth side, the fifth side having the second width. In an embodiment the fifth side has a length of less than about 100 nm. In an embodiment the energy source is a deep ultraviolet energy source. In an embodiment the energy source is an extreme ultraviolet energy source. In an embodiment the first waveguide comprises lithium niobate. In an embodiment the first waveguide comprises aluminum oxide.

In yet another embodiment an optical device includes: a first waveguide over a substrate, the first waveguide comprising a first tapered portion with a first width and a second width, the first width being at least five times greater than the second width; and a second waveguide over the substrate, the second waveguide comprising a second tapered portion, the second tapered portion being located directly over the first tapered portion. In an embodiment the first waveguide comprises aluminum oxide. In an embodiment the first waveguide comprises lithium niobate. In an embodiment the first waveguide comprises silicon. In an embodiment the second width is less than 100 nm. In an embodiment the first width is between about 500 nm and about 2000 nm.

The foregoing outlines features of several embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

What is claimed is:

1. A method of manufacturing an optical device, the method comprising:
placing a substrate on a platform inside an optical imaging device, the optical imaging device comprising a first mask, the first mask having a first opening with a first tapered mask portion having a first shape;
using the first mask to image a photosensitive layer and form a photomask; and
using the photomask to pattern a core material into a first waveguide, the first waveguide having a first tapered portion corresponding to the first tapered mask portion, the first tapered portion having a second shape different from the first shape.

2. The method of claim 1, wherein the second shape comprises a first side with a length that is no greater than about 100 nm.

3. The method of claim 1, wherein the using the first mask to image the photosensitive layer uses extreme ultraviolet light.

4. The method of claim 1, wherein the using the first mask to image the photosensitive layer uses deep ultraviolet light.

5. The method of claim 1, wherein the core material comprises aluminum oxide.

6. The method of claim 1, wherein the core material comprises lithium niobate.

7. The method of claim 1, further comprising forming a second waveguide over the substrate, the second waveguide comprising a second tapered portion directly overlying the first tapered portion.

8. A method of manufacturing an optical device, the method comprising:
forming a first waveguide over a substrate, the first waveguide comprising a first tapered portion with a first width and a second width, the first width being at least five times greater than the second width; and
forming a second waveguide over the substrate, the second waveguide comprising a second tapered portion, the second tapered portion being located directly over the first tapered portion.

9. The method of claim 8, wherein the forming the first waveguide comprises:
placing a first mask into an optical imaging device, the first mask comprising a first opening for a first tapered mask portion with a first side and a second side extending to a first tip;
placing the substrate into the optical imaging device;
patterning an energy source through the first mask to form a patterned energy source; and
using the patterned energy source to form the first waveguide, wherein the first waveguide comprises a third side corresponding to the first side, a fourth side corresponding to the second side, and a fifth side extending from the third side to the fourth side, the fifth side having the second width.

10. The method of claim 9, wherein the fifth side has a length of less than about 100 nm.

11. The method of claim 10, wherein the energy source is a deep ultraviolet energy source.

12. The method of claim 10, wherein the energy source is an extreme ultraviolet energy source.

13. The method of claim 8, wherein the first waveguide comprises lithium niobate.

14. The method of claim 8, wherein the first waveguide comprises aluminum oxide.

15. An optical device comprising:
a first waveguide over a substrate, the first waveguide comprising a first tapered portion with a first width and a second width, the first width being at least five times greater than the second width; and
a second waveguide over the substrate, the second waveguide comprising a second tapered portion, the second tapered portion being located directly over the first tapered portion.

16. The optical device of claim 15, wherein the first waveguide comprises aluminum oxide.

17. The optical device of claim 15, wherein the first waveguide comprises lithium niobate.

18. The optical device of claim 17, wherein the first waveguide comprises silicon.

19. The optical device of claim 15, wherein the second width is less than 100 nm.

20. The optical device of claim 15, wherein the first width is between about 500 nm and about 2000 nm.
